(19) United States
(12) Patent Application Publication
(10) Pub. No.: US 2006/0215712 A1
(43) Pub. Date: Sep. 28, 2006

(54) Method and arrangement for the efficient generation of short-wavelength radiation based on a laser-generated plasma

(75) Inventors: Christian Ziener, Jena (DE); Frank Flohrer, Kahla (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: XTREME technologies GmbH

(21) Appl. No.: 11/388,665

(22) Filed: Mar. 24, 2006

(30) Foreign Application Priority Data
Mar. 24, 2005 (DE) 10 2005 014 433.0

(51) Int. Cl. H01S 3/00; H01S 3/091; H01S 3/22; H01S 3/30; H01S 3/092; H01S 3/223

(52) U.S. Cl. 372/2; 372/5; 372/56; 372/70

(57) ABSTRACT

The invention is directed to a method and an arrangement for the efficient generation of intensive short-wavelength radiation based on a plasma. The object of the invention is to find a novel possibility for the generation of intensive short-wavelength electromagnetic radiation, particularly EUV radiation, which permits the excitation of a radiation-emitting plasma with economical gas lasers (preferably CO₂ lasers). This object is met, according to the invention, in that a first prepulse for reducing the target density is followed by at least a second prepulse which generates free electrons in the target by multiphoton ionization after a virtually complete recombination of free electrons generated by the first prepulse has taken place due to a long-lasting expansion of the target for reducing the target density, and the main pulse of a gas laser with a low critical electron density typical for its wavelength is directed to the target immediately after the second prepulse when the second prepulse in the expanded target, whose ion density corresponds to the critical electron density of the gas laser, has created enough free electrons so that an efficient avalanche ionization is triggered by the main pulse of the gas laser until reaching the ionization level for the desired radiation emission of the plasma.

### CROSS-REFERENCE TO RELATED APPLICATION

This application claims priority of German Application No. 10 2005 014 433.0, filed Mar. 24, 2005, the complete disclosure of which is hereby incorporated by reference.

### BACKGROUND OF THE INVENTION

a) Field of the Invention

The invention is directed to a method and an arrangement for the efficient generation of intensive short-wavelength radiation based on a plasma, wherein a plurality of laser beams are directed to a target flow in a vacuum chamber and, by means of a defined pulse energy, completely transform portions of the target flow into a dense, hot plasma which emits, in particular, short-wavelength radiation in the extreme ultraviolet (EUV) range, i.e., in the wavelength region from 1 nm to 20 nm.

The invention is used as a light source of short-wavelength radiation, preferably for EUV lithography in the fabrication of integrated circuits. However, it can also be used for incoherent light sources in other spectral regions from the soft x-ray region to the infrared spectral region.

b) Description of the Related Art

In order to produce increasingly faster integrated circuits, it is necessary that the width of the individual structures on a chip becomes increasingly smaller. Since the resolution in optical lithographic methods is proportional to the wavelength of the light that is used, development has turned to increasingly smaller wavelengths, currently to wavelengths in the extreme ultraviolet (EUV) spectral region. At present, EUV lithography in the wavelength region around 13.5 nm certainly has the best prospects for the future.

For economical fabrication of semiconductor chips, a determined throughput of wafers per time unit must be ensured in projection lithography. This requires a light source having a high minimum output at a defined efficiency of the imaging optics. To date, there is no light source in the wavelength region around 13.5 nm that is capable of providing the required outputs compatible with the process. Based on the present state of knowledge, laser-generated plasmas, discharge plasmas and synchrotrons are the most promising radiation sources for EUV lithography. Sources based on a plasma have the advantage that they can be incorporated relatively easily into existing production processes.

Average laser outputs of several kilowatts (between 10 kW and 30 kW) are required for generating a laser-produced plasma emitting the EUV outputs needed for chip fabrication. Required pulse lengths for the individual pulse are between about 100 ps and several microseconds (μs). Lasers that could be operated with the above-mentioned parameters for the generation of plasma are gas lasers (CO₂ lasers with a wavelength of 10.6 μm, excimer lasers with wavelengths between 200 nm and 400 nm) and solid-state lasers (usually Nd:YAG lasers with a wavelength of 1.06 ηm). Even when attempting to generate the required output with a plurality of lasers (by time multiplexing of lasers of identical construction), the average laser output of an individual laser module must still be in the region of 1 kW to 5 kW.

For efficient coupling of laser radiation into a target, it is known from the literature that the electron density in the target must be near the critical density for the respective laser wavelength. The critical electron density is nₑ=10²¹ cm⁻³ for Nd:YAG lasers (λ=1.06 μm) and nₑ=10¹⁹ cm⁻³ for CO₂ lasers (λ=10.6 μm). With a particle density of a solid of n=10²³ cm⁻³, the particle density (electron density) of the target must be reduced for favorable absorption of the laser radiation by the target. According to the prior art (see, e.g., Düsterer et al., Appl. Phys. B76 (2003) 17-21 and other references cited therein), this can be realized by directing a prepulse to a solid-density target (solid or liquid). In so doing, the target expands at acoustic speed, typically on the order of 10⁴ m/s, to a diluted target with which the main pulse is absorbed more efficiently.

The ionization of the target material takes place on one hand by photoionization and on the other by impact ionization (avalanche ionization). For the latter, it is necessary that there are already some free electrons present which can be accelerated in the laser field to ionize additional atoms through impact. However, the first free electrons must be generated by photoionization.

When the energy of a laser photon is greater than the ionization energy of a target atom, the ionization is carried out by means of a simple photoionization. However, in atoms whose ionization energy is greater than the energy of a laser photon, a multiphoton ionization is necessary for ionization. In this connection, the ionization rate is highly dependent on the intensity of the laser:
Γ=σIⁿ,
where σ is the effective cross section, I is the intensity of the laser radiation, and n is the quantity of laser photons needed for multiphoton ionization. The quantity n of required laser photons is given by the ionization energy of the atom Eᵢₒₙ and the photon energy of the laser Eₚₕₒₜₒₙ:
n=Eᵢₒₙ/Eₚₕₒₜₒₙ.

The energy of a photon of a Nd:YAG laser is around 1.2 eV, but that of a CO₂ laser photon is only around one tenth of that.

Referring to xenon, which is currently preferred for use for targets for EUV radiation generation and in which an atom has an ionization energy of 12.1 eV, eleven Nd:YAG laser photons and about one hundred CO₂ laser photons are required for a simple multiphoton ionization of the Xe atom. This shows that the necessary intensity for an ionization of neutral xenon using a CO₂ laser must be several orders of magnitude higher than when using a Nd:YAG laser. This ratio is given by the energy of the respective laser and does not depend upon the target materials (e.g., tin).

The temperature of the plasma generated by the incident laser light is dependent not only upon the wavelength of the laser radiation, but also upon the intensity; that is, if the plasma should preferably emit light of a determined wavelength, the intensity of the laser can no longer be freely selected. But this also determines the likelihood of ionization. This substantially limits the possibility of using CO₂ lasers for the generation of plasmas which preferably radiate in the extreme ultraviolet spectral region.

### OBJECT AND SUMMARY OF THE INVENTION

It is the primary object of the invention to provide a novel possibility for the generation of intensive short-wavelength electromagnetic radiation, particularly EUV radiation, which permits the excitation of a radiation-emitting plasma with economical gas lasers (preferably CO₂ lasers) without having to forgo the advantages of laser-induced plasmas based on solid-density targets.

In a method for the efficient generation of intensive short-wavelength radiation based on a laser-generated plasma in which at least one laser is directed to a near-solid-density target located in a vacuum chamber, wherein a prepulse for reducing the target density and a main pulse for avalanche ionization and for generation of a radiation-emitting plasma are generated successively, the above-stated object is met, according to the invention, in that the first prepulse is followed by at least a second prepulse which generates free electrons in the target by multiphoton ionization after a virtually complete recombination of free electrons generated by the first prepulse has taken place due to a long-lasting expansion of the target for reducing the target density, and in that the main pulse of a gas laser with a low critical electron density typical for its wavelength and a focus diameter which is adapted to the target diameter that is increased by the prepulses is directed to the target immediately after the second prepulse when the second prepulse in the expanded target, whose ion density corresponds to the critical electron density of the gas laser taking into account the average ionization level of the target needed for the efficient generation of EUV radiation, has created enough free electrons so that an efficient avalanche ionization is triggered by the main pulse of the gas laser until reaching the ionization level of the target required for the desired radiation emission of the plasma.

The time interval between the first prepulse and the main pulse is governed by the time needed for the target to expand to the density necessary for an efficient EUV generation.

When using xenon or tin or tin compounds as target materials and when the plasma should emit extreme ultraviolet radiation, the time interval between the first prepulse and the main pulse is between 10 ns and 1 μs. The second prepulse serving to ionize the target is advisably directed to the target in such a way that its maximum is active at the target at a point in time when the instantaneous intensity at the leading edge of the main pulse is between 0 and 5% of the peak intensity of the main pulse. In other words, the main pulse is directed to the expanded target before the maximum of the second prepulse is exceeded, so that, at the maximum of the second prepulse, the instantaneous intensity of the main pulse is between 0 and 5% of the peak intensity of the main pulse. Losses in the main pulse (e.g., due to transmission) are minimized in this way.

The time interval between the two prepulses and, therefore, essentially also the time interval between the first prepulse and the main pulse is preferably several hundred ns.

The main pulse is advantageously focused on the target by at least one CO₂ laser. The main pulse is preferably formed of pulses from a plurality of CO₂ lasers which are focused simultaneously on the target (spatial multiplexing).

Main pulses from a plurality of CO₂ lasers can also advisably be focused on the target successively (time multiplexing). Further, it is also possible to combine time multiplexing and spatial multiplexing.

Since the prepulses for efficient multiphoton ionization should have a wavelength of 1 μm or less, either solid-state lasers with a corresponding wavelength (e.g., Nd:YAG lasers, Nd:YLF lasers, Nd:YVO₄ lasers, and so on) or excimer lasers (e.g., ArF lasers, KrF lasers, XeCl lasers, and so on) are advantageously used as prepulse lasers. This is by no means an exhaustive list of possible laser types; any laser having the necessary characteristics such as a wavelength of less than 1 μm, a pulse duration on the order of 10 ns, and a pulse energy of several 10 mJ can be used.

Further, in an arrangement for the efficient generation of intensive short-wavelength radiation, in particular EUV radiation, based on a laser-generated plasma in which at least one laser is directed to a near-solid-density target which is located in a vacuum chamber, wherein the laser has means for triggering a prepulse for reducing the target density and a main pulse for the generation of a radiation-emitting plasma, the above-stated object is met, according to the invention, in that separate prepulse lasers and main-pulse lasers are provided, wherein at least one gas laser with a low critical electron density typical for its wavelength is provided as a main-pulse laser, and in that a synchronization unit is connected to at least one main-pulse laser and to at least one prepulse laser for generating a pulse sequence of at least two prepulses and one main pulse, wherein at least a second prepulse following a first prepulse is provided for a new or a further ionization of the target after a recombination of free electrons that has occurred in the target during the reduction of the target density.

Means for adapting a focus diameter which is realized on the target to a target diameter which is increased due to the reduced target density are advantageously provided for at least one prepulse laser, so that the focus diameter is adapted to the increased target diameter after the first prepulse for every additional prepulse.

At least one short-wavelength laser with a wavelength less than or equal to 1 μm is advantageously provided for generating the prepulses. A solid-state laser, e.g., Nd:YAG laser (with a laser wavelength of 1064 nm or with doubled, tripled or quadrupled frequency which corresponds to wavelengths of 532 nm, 355 nm or 266 nm) or Nd:YLF lasers, Nd:YVO₄ lasers, and so on, or excimer lasers, e.g., ArF lasers, KrF lasers, XeCl lasers or XeF lasers (with wavelengths of 193 nm, 248 nm, 308 nm or 351 nm), are advantageously used as short-wavelength prepulse lasers.

CO₂ lasers are advantageously used as gas lasers for generating the main pulse.

In order to increase the excitation energy available for the main pulse, the main pulse is advantageously composed of pulses from a plurality of CO₂ lasers through spatial multiplexing in that the lasers are triggered simultaneously by the synchronization unit.

On the other hand, the average output of the main pulse acting on the target can also be increased in that the main pulses of a plurality of CO₂ lasers are directed to the target by time multiplexing. It is also useful to combine spatial multiplexing and time multiplexing of CO₂ lasers.

For suitable excitation of the target in a sequence of multiple pulses, prepulse lasers and main-pulse lasers are advantageously directed to the target in collinearly guided beam bundles. However, they can also be oriented to the target in beam bundles that are guided separately next to one another.

In order to generate the prepulses and the main pulse, there are advantageously two prepulse laser beam bundles and two main-pulse laser beam bundles which are directed respectively from opposite sides to an optical axis of a collector that is provided for focusing the radiation emitted by the plasma and to a target flow that can be provided in a reproducible manner, and a target axis of the target flow intersects the optical axis of the collector and the prepulse laser bundles and main-pulse laser bundles are directed to this intersection point (interaction point).

A concave mirror with a dielectric layer system is preferably used as a collector for focusing the radiation emitted by the plasma. However, metal mirrors with grazing light incidence can also be used as collectors. The mirrors can be shaped as ellipsoids, paraboloids, hyperboloids or combinations of such solids of revolution.

In order to generate the prepulses and the main pulse, there are advantageously two prepulse lasers and two main-pulse lasers which are directed respectively from two opposite sides to an optical axis of a collector that is provided for focusing the radiation emitted by the plasma and to a target flow that can be provided in a reproducible manner along a target axis, wherein the target axis intersects the optical axis of the collector and the prepulse lasers and main-pulse lasers are directed to this intersection point.

The beam bundles of the prepulse lasers and main-pulse lasers directed to the target are advantageously arranged at an obtuse angle relative to one another so as to be symmetric in pairs with respect to an axis lying in a plane defined by the optical axis of the collector and the target axis, so that components of the beam bundles transmitted through the target cannot enter prepulse lasers or main-pulse lasers on the other side. The beam bundles of the prepulse lasers and main-pulse lasers directed to the target can advantageously be arranged so as to be axially symmetric to the optical axis of the collector or axially symmetric to the target axis.

A collector provided for focusing the radiation emitted from the plasma is advisably constructed as a concave mirror with a dielectric layer system. It can advantageously be constructed as a paraboloid for direct reflection and focusing of the radiation or can be composed of a plurality of rotationally symmetrical shells with metallic interior coating, preferably of palladium, for grazing reflection of the radiation.

The target material is preferably provided along a vertical target axis in a reproducible manner in a discontinuous sequence of individual targets. Xenon is preferably used as target material. It sometimes proves advantageous when the target material is in frozen form prior to the impact of the first prepulse. A suitable target material for this purpose is xenon in liquid or solid state. Another preferred target material is tin, which can be introduced into the vacuum chamber in pure form or in the form of compounds.

The invention is based on the idea that for the generation of a plasma preferably emitting radiation in the extreme ultraviolet wavelength range using a CO₂ laser there is a conflict between the permissible excitation intensity at the interaction point, which is relatively low because of the low plasma temperature required for efficient EUV generation, and the high excitation intensity required for photoionization of a target material with solid density (i.e., in solid or liquid form) due to the large wavelength of the CO₂ laser, so that known double-pulse excitation with a prepulse and a main pulse is not possible.

The invention solves this problem through a sequence of at least two prepulses and one main pulse. From a target with solid-state density, the first prepulse serves to generate a target which is preionized by multiphoton ionization and which expands and accordingly reaches an ion density that is necessary for efficient EUV generation and which comes close to the critical electron density of the main pulse. At least a second prepulse immediately preceding the main pulse provides for a new preionization in the sufficiently expanded target and therefore for the free electrons needed for avalanche ionization (impact ionization), since the pre-plasma generated prior to this during the expansion of the target is mostly recombined and therefore neutralized again when it has the reduced density required for the gas laser pulse. The main pulse follows immediately after the maximum of the last prepulse and ionizes the generated pre-plasma further to achieve a hot plasma with an ionization level that is suitable for efficient generation of the desired emission wavelength.

The solution according to the invention makes it possible to generate intensive short-wavelength electromagnetic radiation, in particular EUV radiation, which permits the excitation of the radiation-emitting plasma with economical gas lasers (preferably CO₂ lasers) without having to forgo the advantages of laser-induced plasmas based on liquid or solid targets (e.g., liquefied or frozen noble gases, metals, or metal compounds).

The invention will be described more fully in the following with reference to embodiment examples.

### BRIEF DESCRIPTION OF THE DRAWINGS

In the drawings:

FIG. 1 shows the basic flow of the method according to the invention with respect to time;

FIG. 2 is a graph showing the time curve of the intensity of a laser pulse to illustrate the physical backgrounds of the target ionization using a CO₂ laser compared to a Nd:YAG laser;

FIG. 3 shows a possible arrangement of prepulse lasers and main-pulse lasers in which the prepulses are generated by the same laser and the prepulse and main pulse are focused in a beam bundle on the target;

FIG. 4 shows another arrangement in which a prepulse laser and a main-pulse laser are directed to the target from two sides;

FIG. 5 shows another possible arrangement in which the beam bundles of the prepulse laser and main-pulse laser are divided up and focused on the target from two sides;

FIG. 6 shows a constructional variant in which the beam bundles of a plurality of main-pulse lasers are first combined by time multiplexing to form a bundle and are then divided up for directing prepulse bundles and main-pulse bundles to the target from two sides;

FIG. 7 is a flowchart showing the generation of a main pulse according to FIG. 6, in which the repetition rate of the main pulses 23 is increased by time multiplexing;

FIG. 8 shows an embodiment form of the invention using a collector with grazing light incidence in which an excitation of the target from one side by collinear beam bundles was selected for a simplified illustration of the construction and the reflector is shown from above in addition;

FIG. 9 shows a top view and side view of the bundle geometry from FIG. 3 with non-collinear, separate beam bundles for the prepulses and main pulse on a target sequence that is provided in a reproducible manner;

FIG. 10 is a top view and a side view of a bundle geometry corresponding to FIG. 4 with excitation from two sides by means of collinear beam bundles of prepulses and main pulses;

FIG. 11 shows bundle geometry which is modified from FIG. 4 in which the angular position of the oppositely located collinear beam bundles has been changed with respect to FIG. 10;

FIG. 12 is a top view and side view of the bundle geometry corresponding to FIG. 5 with excitation from two sides by means of non-collinear, separate beam bundles for prepulses and main pulses; and

FIG. 13 shows another bundle configuration with non-collinear beam bundles based on the basic variant in FIG. 5, but with a different angular position of the oppositely arranged separate prepulse and main-pulse bundle, wherein a plurality of main-pulse bundles are provided for increasing the energy introduced into the target by spatial multiplexing of pulses.

### DESCRIPTION OF THE PREFERRED EMBODIMENTS

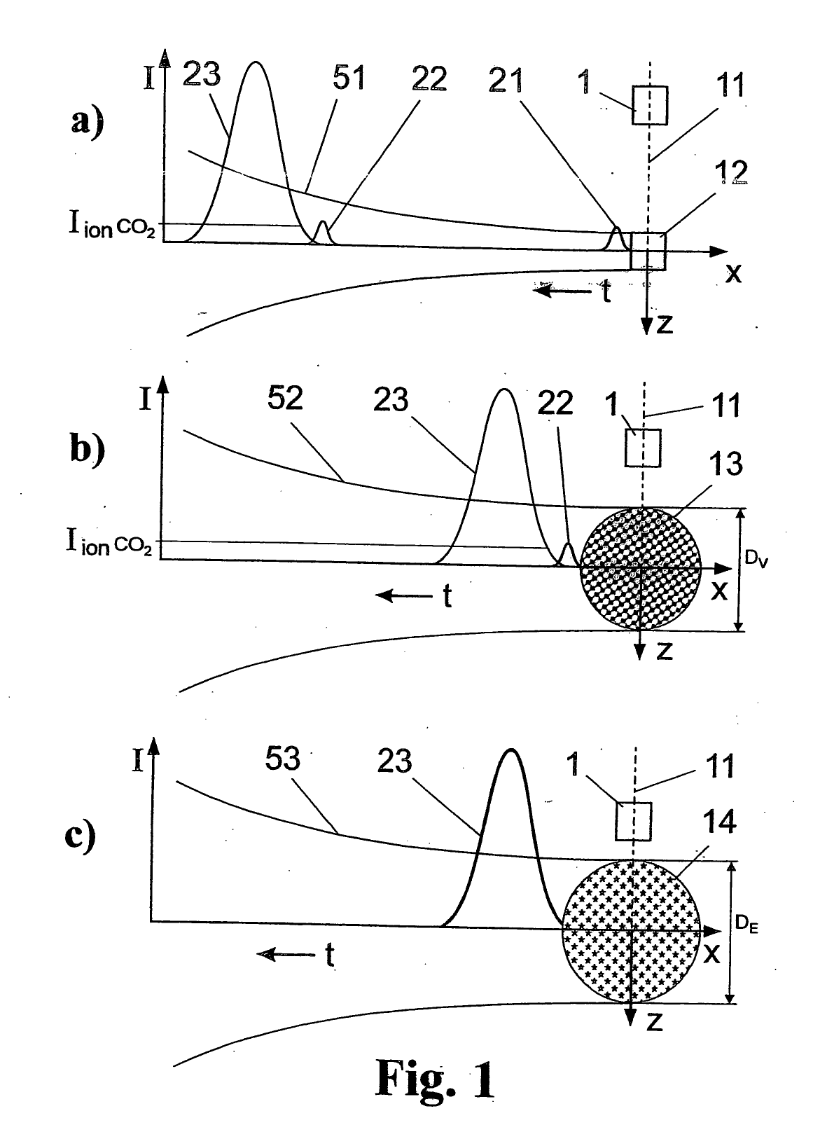

As is shown in a time sequence in FIG. 1, the basic variant of the method according to the invention comprises the following steps:
a suitable target 1 is provided at an interaction point that is provided for plasma generation by a laser pulse;
the target 1 is acted upon by at least a first prepulse 21 for reducing the target density;
the expanded target 13 is acted upon by at least a second prepulse 22 which is adapted to a target diameter Dᵥ that is increased due to the reduced target density, and an initial ionization (free electrons for avalanche ionization for generating a hot plasma) is generated by simple photon ionization or multiphoton ionization;
the expanded and preionized target 14 is irradiated by a main pulse 23 from a CO₂ laser 32 which serves as a main-pulse laser 3 and which has a relatively low critical electron density typical for its wavelength and a focus diameter that is adapted to the increased target diameter D_{E} after the second prepulse 22, the main pulse 23 is directed to the expanded, preionized target 14 and, by avalanche ionization of its electron density, is further increased until a hot plasma emits radiation of the desired wavelength.

From an initial target 12 having solid-state density (i.e., it is either solid or liquid), the first prepulse 21 serves to generate an expanded target 13 whose density comes close to the critical density of a CO₂ laser provided for the main pulse 23. The prepulse laser 4 should have the smallest possible wavelength (λ₁≦1μm) so that it can be coupled in as efficiently as possible. Further, the first prepulse bundle 51 is focused on the initial target 12 by suitably adjustable optical elements in such a way that the focus diameter of the laser beam approximately corresponds to the target diameter (of an initial target 12 which is assumed to be cylindrical).

A second prepulse 22 serves to ionize anew the target 13 that was recombined during the expansion and consequently at least partially neutralized and, therefore, to generate anew the free electrons needed for the avalanche ionization (impact ionization). This second prepulse 22 should also have as short a wavelength as possible (λ₁≦1 μm) so that the intensity needed for the ionization can be kept as low as possible. Further, the focusing of the second prepulse bundle 52 is adapted to the larger diameter of the expanded target 13.

Any lasers can be used for the two prepulses 21 and 22. Solid-state lasers, preferably Nd:YAG lasers, and excimer lasers are used as prepulse lasers 4 in order to ensure that the required pulse repetition frequencies of 10 kHz and pulse energies of several 10 mJ are achieved. Both families of lasers are currently capable of achieving pulse repetition frequencies of 10 kHz and pulse energies of several 10 mJ.

The main pulse 23 is generated by one or more CO₂ lasers. The main pulse 23 follows the final (in this case, second) prepulse 22 immediately in time and further ionizes the target 14, which is generated by the second prepulse 22 and which has been expanded and sufficiently preionized, until reaching the ionization stage necessary for efficient generation of the desired wavelength. For this purpose, the focus diameter of the main-pulse laser 3 must likewise be adapted to the diameter of the expanded, preionized target 14 in order to prevent portions of the expanded target 14 from lying outside of the focus of the main-pulse bundle 53 and therefore not being optimally excited or to prevent portions of the main-pulse bundle 53 from “overshooting” the target 14 resulting in a loss of energy of the main pulse 23 for the conversion of energy into the desired radiation (EUV).

The choice of circular focal spots does not represent a limiting of generality. It would also be possible to use line foci. Accordingly, at a given diameter of the target, the amount of material to be vaporized or heated can be freely selected within determined limits.

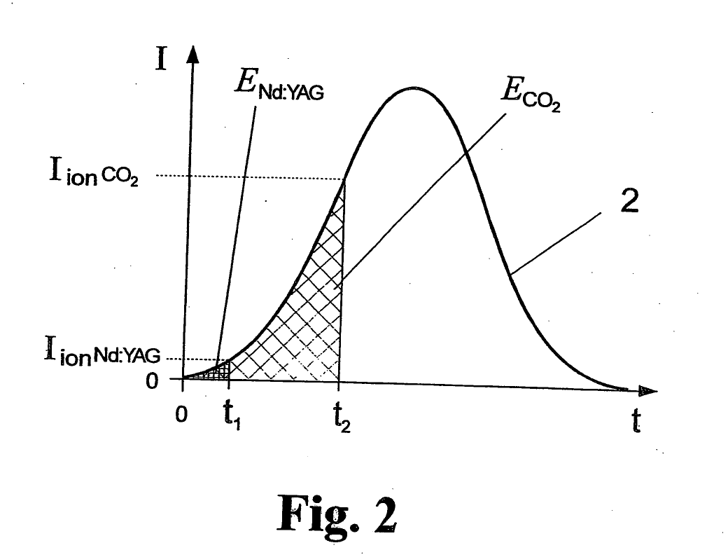

FIG. 2 shows a schematic representation of the time curve of the intensity of a laser pulse to describe the physical backgrounds for the process flow for generating a hot plasma which reproducibly emits intensive radiation of a desired wavelength range (e.g., EUV). The respective intensities for a CO₂ laser and a Nd:YAG laser with which the electron density generated in the target 1 by multiphoton ionization is sufficient to serve as a starting point for an avalanche ionization (impact ionization) are indicated by Iᵢₒₙ_{^{CO}}₂ and Iᵢₒₙ_{^{Nd:YAG}}. Since the photon energy of a CO₂ laser is about ten-times less than that of the Nd:YAG laser, the intensity required for multiphoton ionization is correspondingly higher. The times at which the intensity of the laser is sufficient to provide the electron density needed for the avalanche ionization are designated by t₁ (for the Nd:YAG laser) and t₂ (for the CO₂ laser). Before the intensities Iᵢₒₙ_{^{CO}}₂ and I ᵢₒₙ_{^{Nd:YAG}} are reached, the target 1 is approximately transparent. Therefore, the portion of the laser pulse 2 that is lost due to transmission or that cannot be used for generating the hot, emitting plasma is shown in the shaded area. As can be seen from FIG. 2, the proportion of inconvertible laser energy E_{CO}_{₂} shown in cross-hatching is much larger for the CO₂ laser than the proportion of inconvertible laser energy E_{Nd:YAG}, shown in smaller hatching, for a Nd:YAG laser with a wavelength that is ten-times shorter. The Nd:YAG laser serves only as an example of a shorter-wavelength laser and the fact that its use as prepulse laser 4 is preferred in the following does not represent a limiting of generality. Also, other solid-state lasers with the corresponding wavelength (e.g., Nd:YLF lasers, Nd:YVO₄ lasers, and so on) or excimer lasers (e.g., ArF lasers, KrF lasers, XeCl lasers, and so on) can also be used as prepulse lasers. For excimer lasers in particular, the energy of a photon would be even higher than for the Nd:YAG laser indicated in FIG. 2.

FIG. 1 shows schematically the course of the interaction between three laser pulses 2, which are triggered with a time delay, and a target 1 which is struck in different excitation states due to the successive application of pulses.

As can be seen in FIG. 1a, an initial target 12 is struck by a first short-wavelength prepulse 21. The initial target 12 has a diameter of several tens of micrometers (e.g., 20 μm) and has solid-state density (i.e., it is either in solid or liquid form). The first prepulse 21 is focused on the initial target 12 in such a way that the focus diameter is equal to or somewhat greater than the target diameter. The initial target 12 is partially ionized by multiphoton ionization; the prepulse deposits its energy in the target 12 (generates a pre-plasma, as it is called) and the target 12 expands.

In FIG. 1b, the expanded target 12 has already reached a density which is reduced in this way and which would be optimal for the absorption of the main pulse 23 at the ionization level needed for the efficient generation of EUV radiation. However, since the elapsed time for achieving this reduced density in the expanded target 13 exceeds the average lifetime of the free electrons generated by the prepulse 21, virtually all of the free electrons in the expanded target 13 are recombined. This means that the pre-plasma is almost neutralized, so that a main pulse 23 from a CO₂ laser impinging at this time would be transmitted until it has created the free electrons needed for an avalanche ionization through a new multiphoton ionization.

Therefore, a second prepulse 22 is focused on the expanded target 13 prior to the main pulse 23 in such a way that the focus diameter of the second prepulse bundle 52 is adapted to the diameter of the expanded target 13. The second prepulse 22 ionizes the expanded target 13 again and generates the free electrons which are needed for the avalanche ionization through the main pulse 23 so that there is an expanded, preionized target 14 as optimal pre-plasma for the immediately following main pulse 23.

Assuming that the ion density of the initial target 12 for material that is ionized ten times must be reduced by five orders of magnitude in order to reach the critical electron density of the CO₂ laser, then the diameter in an isotropically expanded target 13, assumed to be a sphere, increases by a factor of about 50, i.e., a sphere with 20 μm must expand to a diameter of about 1 mm. For this purpose, the target 1 requires a time period on the order of several hundreds of nanoseconds.

During the expansion of a pre-plasma generated by the first prepulse 21, an almost complete recombination of the free electrons occurs within the time period of some 100 ns required for the expansion described above. This means that when the main pulse strikes the expanded target 13, there are no more free electrons available for the absorption of the main pulse 23 and for further ionization by means of avalanche ionization of the target 13, so that the main pulse 23 must generate free electrons again by photoionization.

This does not lead to substantial problems when the prepulse and main pulse are generated by means of a Nd:YAG laser because, as was explained above, a Nd:YAG laser pulse can generate free electrons even at a low intensity in the initial area of the leading edge of the pulse by means of multiphoton ionization, so that “energy losses” caused by transmission through the target 13 are low. As is shown in FIG. 2, a Nd:YAG laser reaches the intensity for a multiphoton photo-ionization of the target ion Nd:YAG already after a very brief time t₁, i.e., only the small portion of the laser pulse prior in time to t₁ is predominantly transmitted through the target 13. After this, there are sufficient free electrons available for an avalanche ionization which lead to the virtually complete absorption of the pulse energy over the remaining pulse duration (after t₁).

As is further shown in FIG. 2, according to the multiphoton ionization described above, a very much higher intensity (I_{ionCO}_{²}>>I_{ionNd:YAG}) is required in the case of a CO₂ laser to generate the free electrons required for avalanche ionization. As a result, a majority of the laser radiation (up to a time t₂ in the schematic view in FIG. 2) is virtually transmitted by the target 13 and can no longer be used to generate a hot plasma emitting the desired (EUV) radiation.

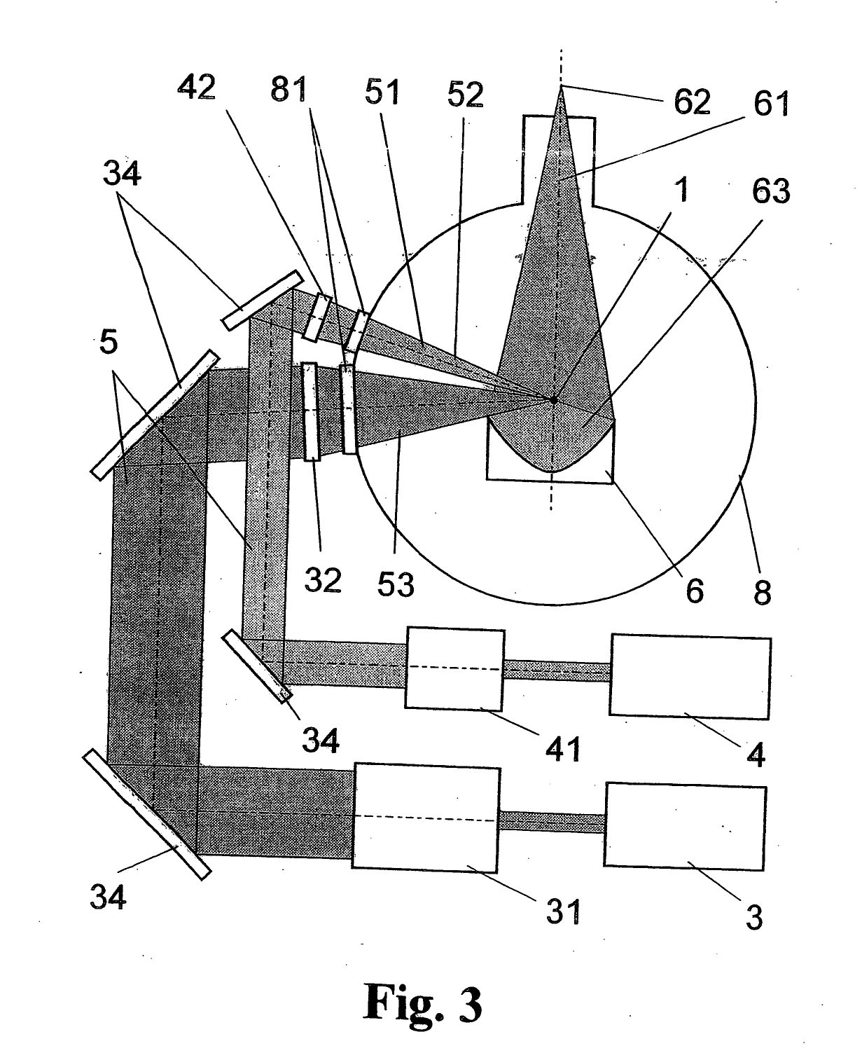

Consequently, in order for a CO₂ laser to be used, according to the invention, as a main-pulse laser 3 (shown only in the following FIGS. 3 to 8), a new ionization must be carried out beforehand in order to generate a sufficient amount of free electrons in the expanded target 13 for the main pulse 23 of a CO₂ laser so that as little laser radiation as possible is transmitted through the target 13. For this purpose, a second prepulse 22 is generated which has characteristics similar to the first prepulse 21, that is, which is also generated as far as possible by a solid-state laser or excimer laser with the parameters described above. The second prepulse 22 strikes the expanded target 13 directly before the main pulse 23 in such a way that it has its maximum intensity shortly after the starting point of the main pulse 23, i.e., before the main pulse reaches approximately 5% of its maximum intensity.

FIG. 3 is a first schematic view showing the generation and radiation of the beam bundles 5 of prepulses 21, 22 and main pulse 23. Both prepulses 21 and 22 are generated by one and the same prepulse laser 4 and are focused on the target 1 along the same optical path as a first and second prepulse bundle 51 and 52, respectively.

The vacuum chamber 8, in which targets 1 are provided in a reproducible manner along a target path 11 extending orthogonal to the drawing plane, has the point of interaction with the target 1 in the drawing plane. A collector 6 which is shaped as an ellipsoid in this case is arranged around the target 1 and bundles the largest possible proportion of emitted EUV radiation in an intermediate focus 62 located outside the vacuum chamber 8. In this example, two windows 81 are provided in the wall of the vacuum chamber 8 in order to focus the first and second prepulse bundles 51 and 52, respectively, on the one hand and the main-pulse bundle 53 on the other hand on the target 1 laterally with reference to the optical axis 61 of the collector 6, i.e., from one side. The prepulse bundles 51 and 52 are emitted by the prepulse laser 4 as two pulses which are generated successively in time in a defined manner in a beam-shaping unit 41 and are directed to the target 1 through a window 81 in the interaction chamber 8 by means of focusing optics 42. After this, the main pulse 53 generated by a main-pulse laser 3 is shaped spatially (e.g., expanded) in a beam-shaping unit 31 and is deflected by means of focusing optics 32 through another window 81 to the expanded and preionized target 14 in the interaction chamber 8. The focusing optics 32 and 42 are shown schematically in FIGS. 3 to 6 as lenses. This does not represent a limiting of generality because mirrors can also be used for focusing the laser bundles 51, 52 and 53 on the target 1. Further, the mirrors or the lenses can also be located within the interaction chamber 8.

In order to ensure the synchronization in time of the main-pulse laser 3 and prepulse laser 4, both lasers 3 and 4 are controlled by a common trigger unit 7 (not shown in FIG. 3).

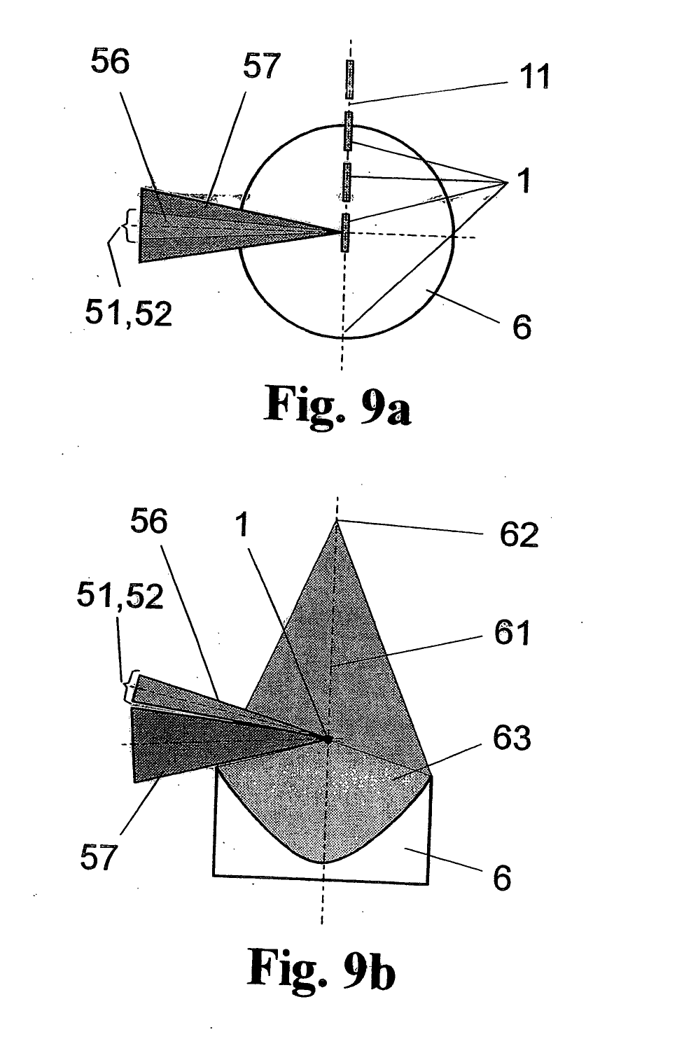

The desired EUV radiation emitted by the hot plasma (only shown as the target 1 that is initially present) arrives in a bundled manner in an intermediate focus 62 through the collector 6. FIG. 9 shows the position of the prepulse bundles and main-pulse bundles 51, 52 and 53 in two planes for this example. However, it is not compulsory that the prepulse bundles 51 and 52 lie in the same plane as the main-pulse bundle 53.

In the variant shown here, the diameter of the prepulses at the interaction point is adapted by shared focusing optics in such a way that the divergence or the diameter, or both, is/are changed in the beam-shaping unit 41 at least for one beam bundle to the extent that the desired diameter can be adjusted at the interaction point. This is carried out in an advantageous manner through the use of one or more telescopes in the beam-shaping unit 41.

In the embodiment example in which the prepulses are generated by a prepulse laser 4 in each instance, but are guided to the target 1 collinearly thereafter, this is made possible, for example, in that the prepulse bundles 51 and 52 have a linear polarization orthogonal to one another, the diameter or the divergence is adapted separately and thereafter the bundles are recombined by means of a polarizing beamsplitter before they are directed collinearly to the target 1.

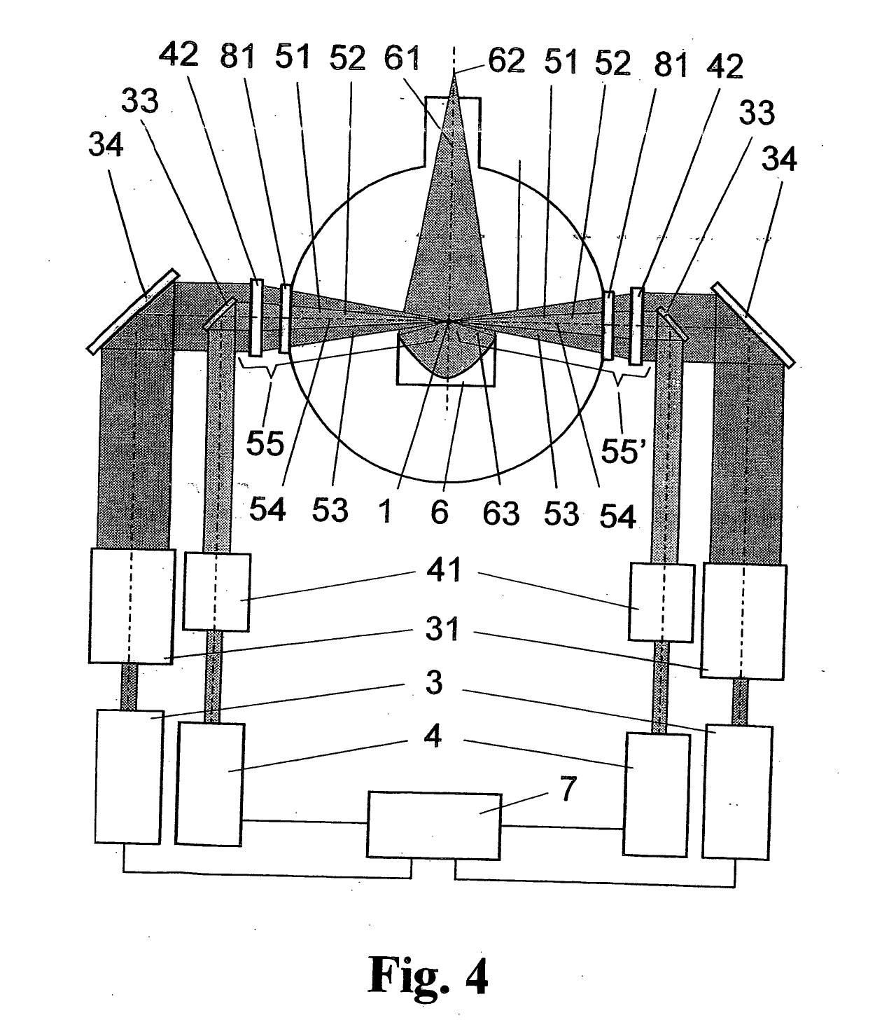

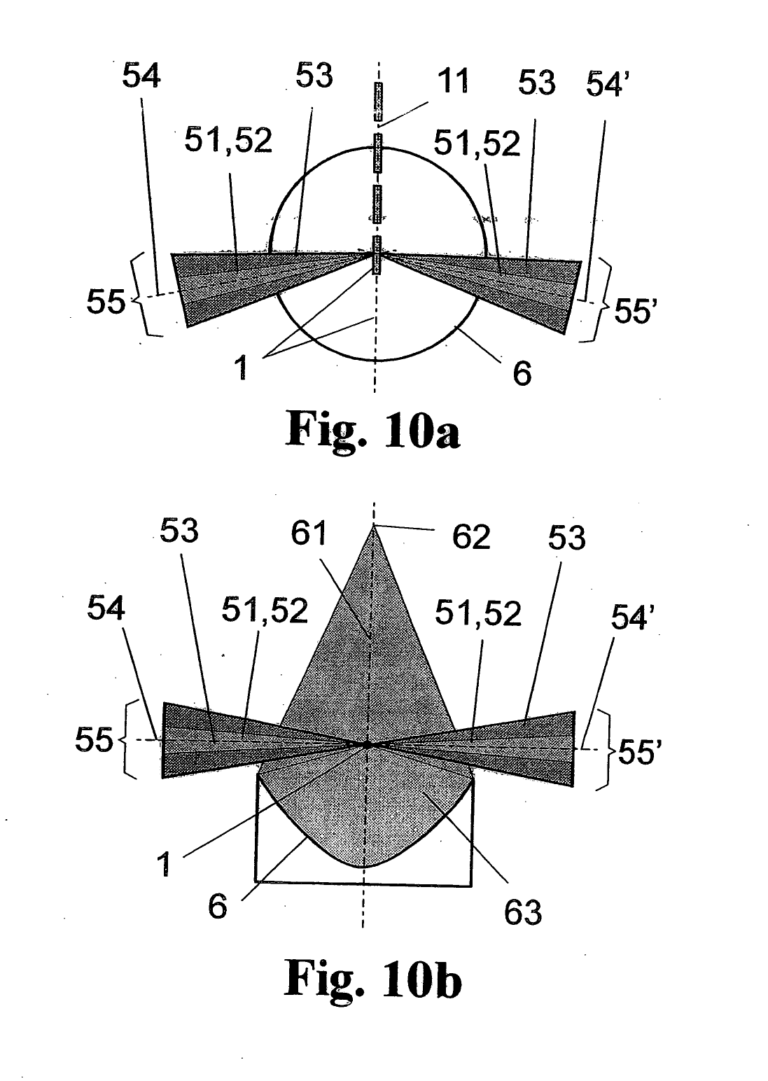

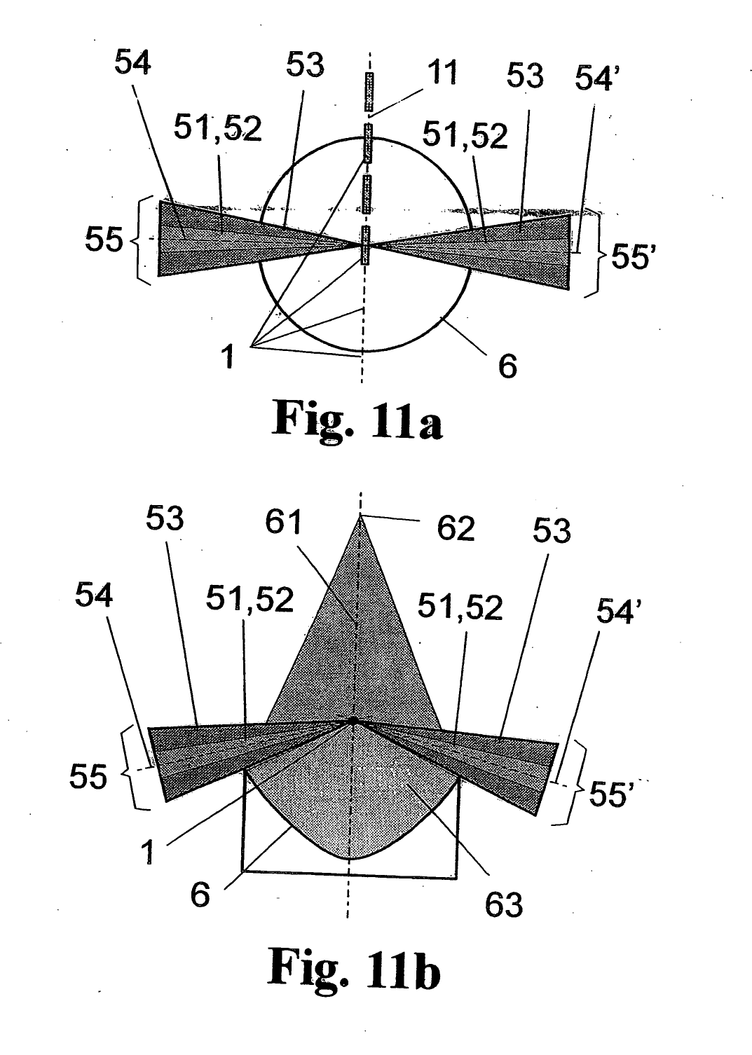

FIG. 4 shows another embodiment example of the invention in which the target 1 is irradiated by the prepulses 51 and 52 as well as by the main pulse 53 from opposite sides with reference to the axis 61 of the collector 6. Collinear beam bundles 55 and 55′ are generated for each side by separate lasers 3 and 4 and are reshaped in beam-shaping units 31 and 41, respectively. The temporal synchronization of the respective two main-pulse lasers 3 and prepulse lasers 4 is carried out by a trigger unit 7. FIGS. 10 and 11 show two possible configurations (in a side view and top view, respectively) for the spatial position of the prepulse bundles 51 and 52 relative to the main-pulse bundles 53, in which the collinear bundles 55 and 55′ (comprising the prepulse bundles and main-pulse bundles 51 to 53) are directed to the target 1 symmetrically from both sides of the optical axis 61 of the collector 6, but the bundle 55 on the left side and the bundle 55′ on the right side have an obtuse or concave angle relative to one another in order to prevent laser light of one collinear bundle 55 from entering the other bundle 55′ (and vice versa). FIGS. 10 and 11 give two different but equivalent solutions for the angular positions of he collinear bundles 55 and 55′ relative to one another for this angular position of the collinear bundles 55 and 55′.

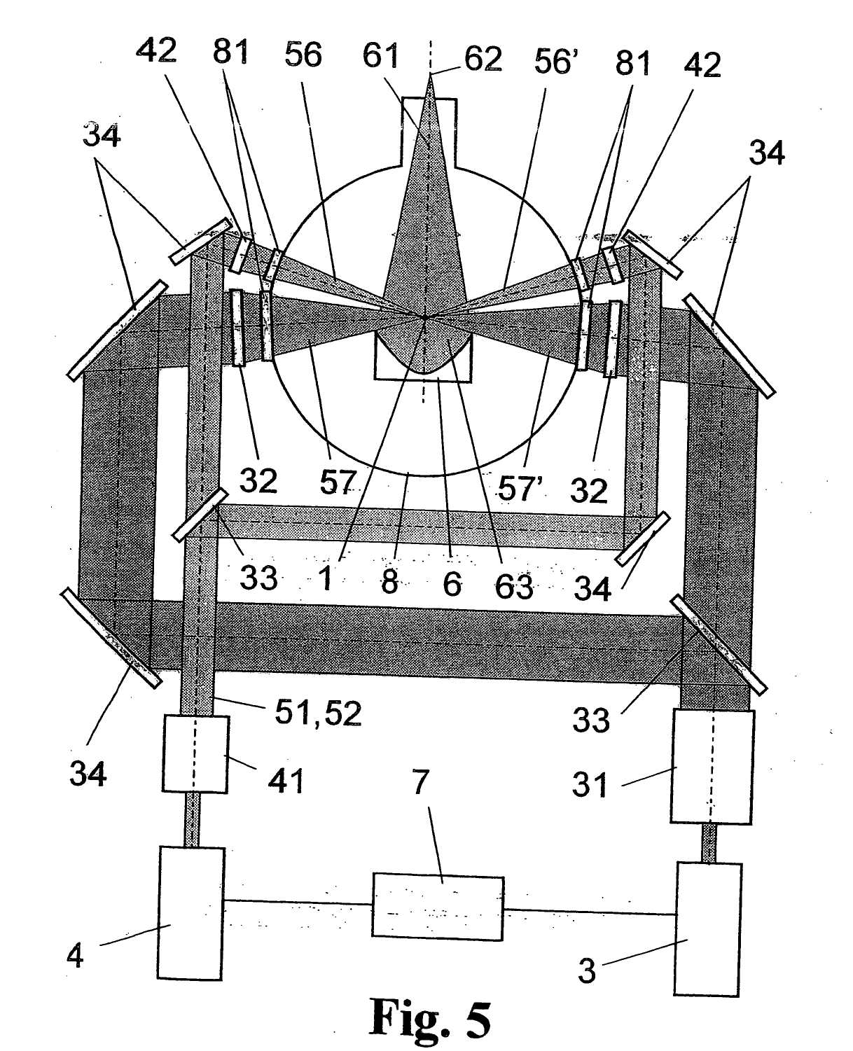

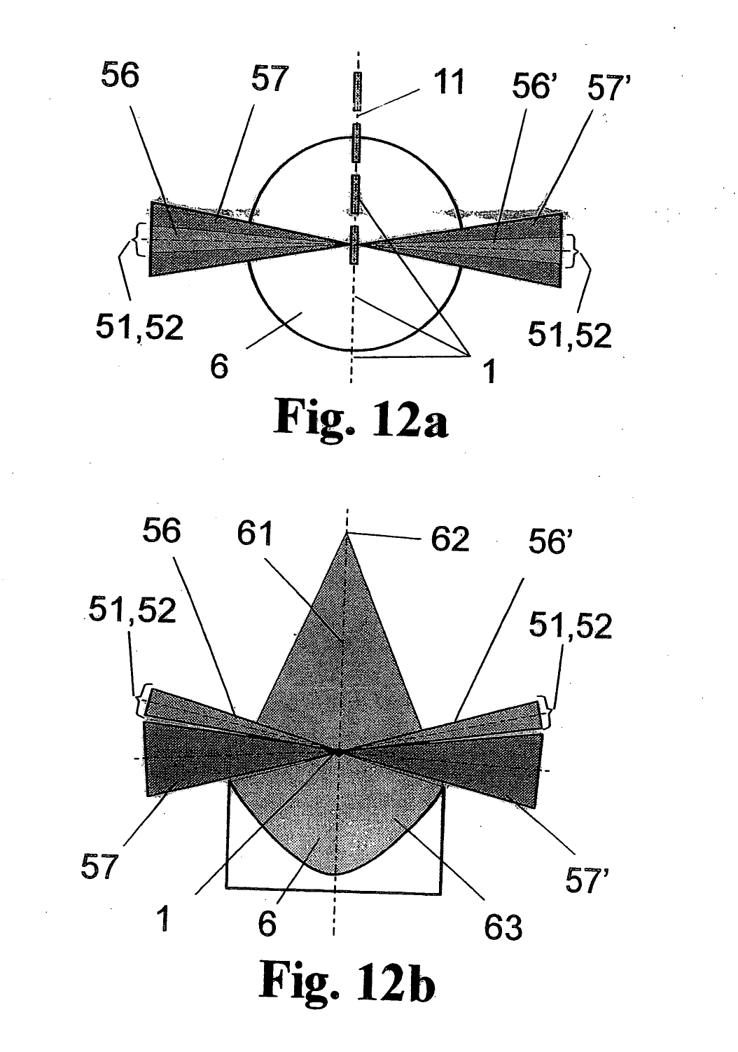

In the variant according to FIG. 5, the target 1 is likewise acted upon on two sides by prepulses 51, 52 and main pulses 53. In contrast to FIG. 4, however, separate prepulse beam bundles 56 and 56′ and main-pulse beam bundles 57 and 57′ are focused (not collinearly) on the target 1. Further, the separate prepulse bundles 56 and 56′ and the main-pulse bundles 57 and 57′ are each generated by means of a beamsplitter 33. FIG. 12 shows a side view of the bundle geometry for this example. Another arrangement for exciting the target 1 that is equivalent to the equivalent bundle configurations in FIG. 9 and FIG. 10 is made possible by switching the side view and the top view.

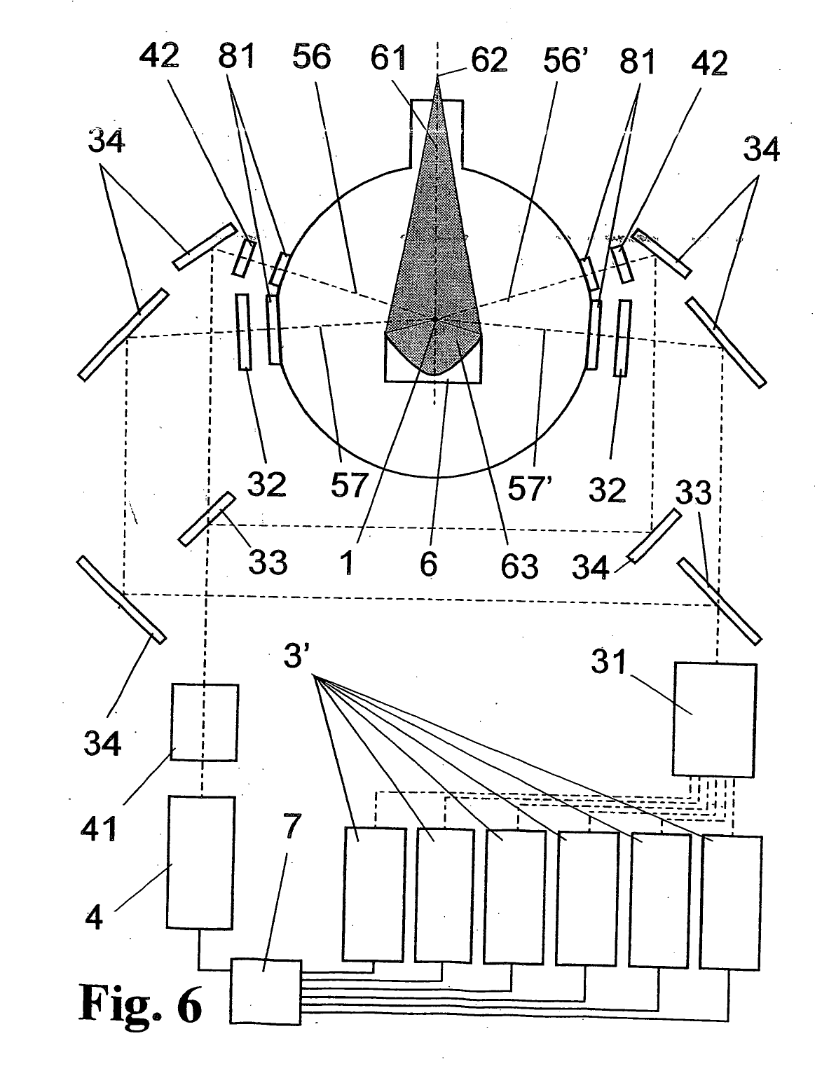

In another embodiment example of the invention according to FIG. 6, in contrast to FIG. 5, the main-pulse bundles 57 and 57′ are generated in that they are unified in a light path by a plurality of main-pulse lasers 3′ in the beam-shaping unit 31. For the sake of simplicity, the beam paths are shown only as optical axes, although the latter are designated as prepulse bundles 56, 56′ and main-pulse bundles 57, 57′. In addition to the prepulse control, the individual main-pulse lasers 3′ are controlled so as to be offset in time by a trigger unit 7 so that the main pulses 23 of different main-pulse lasers 3′ strike the ionized target 14 at different times (time multiplexing of the main pulse 23).

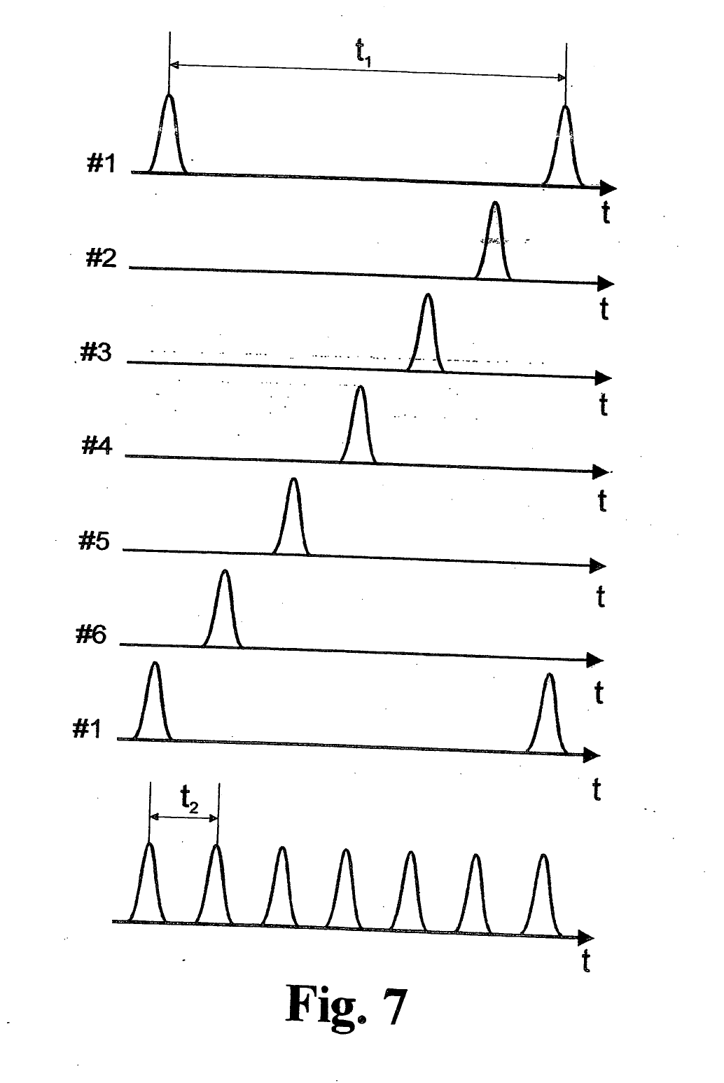

In this connection, the pulses of the main-pulse lasers 3′ strike different ionized targets 14, i.e., targets 14 that are located successively at the interaction point, so that an increase in the repetition rate of the plasma generation is achieved. The principle of this time multiplexing is shown schematically in FIG. 7. The pulses of six individual main-pulse lasers 3′ with an original pulse repetition frequency f=1/t are offset in time in such a way that the resulting pulse repetition frequency F=1/T amounts to six-times the original pulse repetition frequency f. The quantity of main-pulse lasers 3′ in this example (six) is arbitrarily chosen and can be changed depending on the required repetition frequency of the main pulses 23.

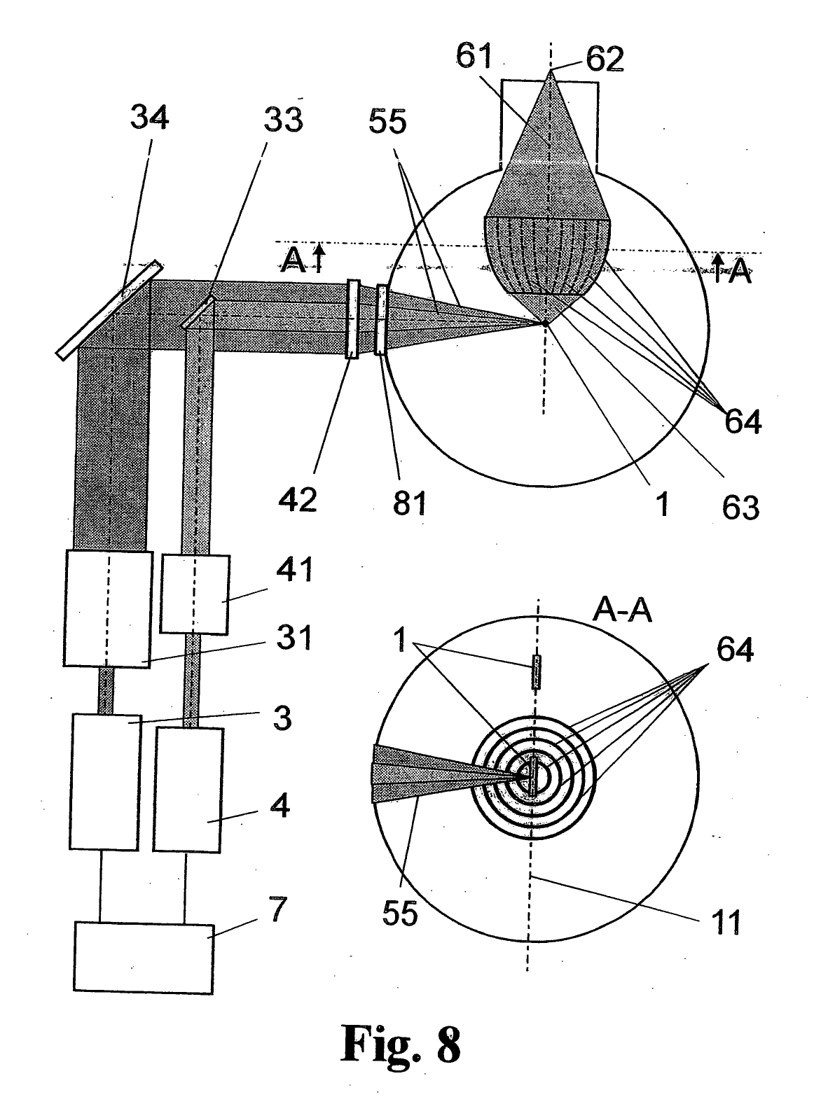

FIG. 8 shows another arrangement of the invention—reduced to a one-sided excitation of the target 1 for reasons of space—which works with collinear beam bundles 55 of prepulse bundles 51, 52 and main-pulse bundles 53. The difference in this case resides in the modified arrangement of the collector which, in this example, comprises mirror shells 64 which are arranged so as to be rotationally symmetric with respect to the optical axis 61 and which bundles the EUV radiation emitted in the acquirable solid angle in the intermediate focus 62 through reflection with grazing light incidence. The mirror shells 64 can be comprised of different solids of revolution, e.g., ellipsoids or a combination of ellipsoids and hyperboloids. The top view at bottom right in FIG. 8 illustrates the construction of a collector 6 with grazing light incidence in which metal mirror shells 64 are preferably used.

FIG. 9 shows the bundle configuration at the target 1 for the embodiment example shown in FIG. 3. This target 1 is provided continuously along a target path 11. Three laser beam bundles (first and second prepulse bundles 51 and 52, respectively, and main-pulse bundle 53 according to FIG. 1) are focused on the target 1 collinearly (along a common axis 54) from one side. In this example, the common axis 54 of the laser beam bundles 5 (hereinafter: collinear beam bundle 55) which is accordingly guided concentrically for prepulse 21 and 22, respectively, and main pulse 23 lies in a plane which is arranged orthogonal to the axis 61 of a collector 6 and the target path 11 of a target 1 that is provided in a reproducible manner extends in this plane. FIG. 9a shows the top view of this plane and the collector 6 located behind it.

As in all of the embodiment examples, the main pulse 23 can be generated by an individual main-pulse laser 3 (CO₂ laser) with a correspondingly high pulse repetition frequency or by a plurality of CO₂ lasers 32 with time multiplexing, i.e., the individual laser pulses (main pulses 53) are coupled in on the common axis 54 by different lasers 3′ and act at the target 1 at different times.

By means of the laser beam bundles 5 in the arrangement shown in FIG. 8, it is possible to transport the maximum proportion of radiation generated by the plasma that can be acquired by the collector 6 in a solid angle 63, and accordingly the maximum usable output, in the intermediate focus 62 generated by the collector for a given focusing of a main-pulse beam bundle 57 (opening angle of the focused laser bundle). Without limiting generality, the collector 6, whose optical axis 61 is also referred to in the following examples, is constructed as a concave mirror which is outfitted with a dielectric layer system for increasing reflectivity. However, in order that the EUV radiation emitted from the hot plasma after the interaction point of the main pulse 23 is collected in a defined solid angle 63, collectors which rely upon grazing incidence of a plurality of mirror shells 64 can also be used, as was already described above with reference to FIG. 8.

FIG. 9 shows a view in two planes, a top view (a) from the direction of the intermediate focus 62 on the collector 6 and a side view (b) orthogonal thereto. This variant of the bundle configuration of the prepulse bundle 56 and the main-pulse bundle 57 is associated with the arrangement of the invention shown in FIG. 3. In this case, all of the laser pulses are focused on the target 1 in that they are directed laterally from one side to the intersection point of the target path 11 and the axis 61 of the collector 6. The light paths are not directed collinearly to the target 1, but rather impinge as separate prepulse beam bundles 56 and main pulse beam bundles 57 at a slight angle relative to one another which lies within the plane of the target path 11. FIG. 9a also shows the path of a reproducible flow of the target 1 along a target path 11 in front of the collector 6 and FIG. 9b corresponds in principle to the view in FIG. 3. In an equivalent variant, not shown, the prepulse bundle 56 and main-pulse bundle 57 which are arranged at an angle to one another can also lie within the drawing plane of FIG. 9a or in a plane between the side view and the top view.

FIG. 10a shows a top view of the collector 6 based on the construction in FIG. 4 in which three laser pulses are focused on the target 1 from two sides in collinear beam bundles 55 and 55′. FIG. 10a shows that the two collinear beam bundles 55 and 55′ which are formed, respectively, of prepulse bundles 51 and 52 and main-pulse bundle 53 are directed to the target 1 at a slight angle (deviating from a point-symmetric juxtaposition, 180°). This ensures that laser light from the collinear beam bundle 55 that is transmitted through the target 1 cannot enter the laser source(s) of the oppositely located collinear beam bundle 55′ (and vice versa). Accordingly, the respective common axes 54 of the collinear bundles 55 and 55′ have an obtuse or concave angle relative to one another at least in one plane.

In this type of excitation from two sides, insofar as the maximum solid angle 63 that can be acquired by the collector 6 for the radiation generated by the plasma is not cropped, it is also possible to switch the positional relationship of the respective collinear beam bundles 55 and 55′ of FIG. 10a and FIG. 10b. FIG. 11 shows a construction of the invention of this kind in which all laser pulses 2 are focused on the target 1 as collinear beam bundles 55 and 55′ in a plane orthogonal to the target path 11 (FIG. 11a) and, within the drawing plane of FIG. 11b which shows this orthogonal plane, enclose an obtuse angle which deviates from the point-symmetric position (180°) of the collinear beam bundles 55 and 55′ by more than their maximum bundle expansion.

FIGS. 12a and 12b show a top view and a side view of a construction of the invention which is modified from the two-sided excitation in FIG. 5. Analogous to FIG. 4, the target 1 is excited simultaneously from positions that are located opposite one another in an axial symmetric manner by separate prepulse beam bundles 56 and main-pulse beam bundles 57 which are not collinear and by beam bundles 56′ and 57′ which are correspondingly arranged in a mirror-symmetric manner.

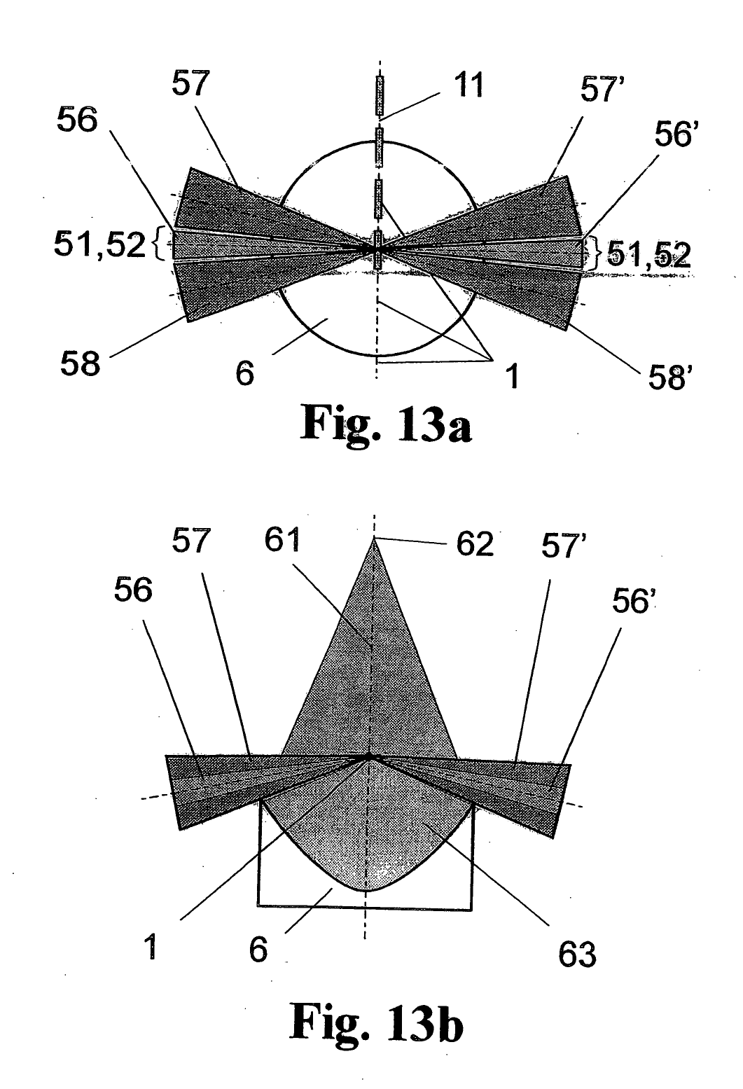

FIG. 13 shows a top view (FIG. 13a) and a side view (FIG. 13b) of another modified embodiment example. In this case, a prepulse beam bundle 56 and (at least) two main-pulse beam bundles 57 and 58 are focused on the target 1 from one side and another prepulse beam bundle 56′, supported by (at least) two main pulse beam bundles 57′ and 58′, is focused on the target 1 from the other side. In this case, as is shown in FIG. 8b, all beam bundles 56, 57 and 58 must be tilted slightly relative to all beam bundles 56′, 57′ and 58′ in order to protect the laser sources (not shown) from a beam component of the oppositely located laser sources that is transmitted by the target 1. This configuration of the beam bundles 5 according to FIG. 8 makes possible a spatial multiplexing of laser pulses, wherein the introduced energy is multiplied by laser pulses 2 interacting with the target 1 at the same time.

In this example, it is assumed that the first prepulses 21 and the second prepulses 22 are radiated within the two prepulse beam bundles 56 and 56′ synchronously and that the hot, emitting plasma is generated by the synchronously operated main-pulse beam bundles 57 and 57′ alternating with the main-pulse beam bundles 58 and 58′ which are likewise pulsed synchronously (time multiplexing). However, it is also conceivable to trigger main pulses 23 simultaneously in all main pulse-beam bundles 57, 57′, 58 and 58′ in order to couple quadrupled laser energy into the target 1 as one excitation (spatial multiplexing).

While the foregoing description and drawings represent the present invention, it will be obvious to those skilled in the art that various changes may be made therein without departing from the true spirit and scope of the present invention.

### REFERENCE NUMBERS

1 target
11 target path
12 initial target
13 expanded target
14 preionized (and expanded) target
2 (laser) pulses
21 first prepulse
22 second prepulse
23 main pulse
3 main-pulse laser
31 beam-shaping unit
32 focusing optics
33 beamsplitter
34 deflecting mirror
4 prepulse laser
41 beam-shaping unit
42 focusing optics
5 beam bundle
51 first prepulse bundle
52 second prepulse bundle
53 main-pulse bundle
54 common axis
55, 55′ collinear beam bundle
56, 56′ separate (prepulse) beam bundle
57, 57′ separate (main pulse) beam bundle
58, 58′ separate (main pulse) beam bundle
6 collector
61 axis
62 intermediate focus
63 acquired solid angle of emitted (EUV) radiation
64 (rotationally symmetric) mirror shells
7 trigger unit
8 vacuum chamber
81 window
D_{V} target diameter (before the second prepulse)
D_{E} target diameter (before the main pulse)
E_{Nd:YAG ionization energy of a Nd:YAG laser}
E_{CO}_{₂} ionization energy of a CO₂ laser
Iᵢₒₙ_{^{Nd:YAG}} ionization intensity of a Nd:YAG laser
Iᵢₒₙ_{^{CO}}₂ ionization intensity of CO₂ laser

What is claimed is:

1. A method for the efficient generation of intensive short-wavelength radiation based on a laser-generated plasma comprising the steps of:
directing at least one laser to a near-solid-density target located in a vacuum chamber;
generating a prepulse for reducing the target density and a main pulse for avalanche ionization and for generation of a hot, radiation-emitting plasma, said prepulse and main pulse being generated successively;
said prepulse being a first prepulse which is followed by at least a second prepulse which generates free electrons in the target by multiphoton ionization after a virtually complete recombination of free electrons generated by the first prepulse has taken place due to a long-lasting expansion of the target for reducing the target density; and
directing the main pulse of a gas laser with a low critical electron density typical for its wavelength and a focus diameter which is adapted to the target diameter (D_{V}) that is increased by the prepulses to the target immediately after the second prepulse when the second prepulse in the expanded target, whose ion density corresponds to the critical electron density of the gas laser taking into account the average ionization level of the target needed for the efficient generation of EUV radiation, has created enough free electrons so that an efficient avalanche ionization is triggered by the main pulse of the gas laser until reaching the ionization level of the target required for the desired radiation emission of the plasma.

2. The method according to claim 1, wherein the time interval between the first prepulse and a final prepulse is between 10 ns and 1 μs.

3. The method according to claim 1, wherein the main pulse is directed to the expanded target before the maximum of the second prepulse is exceeded so that, at the maximum of the second prepulse, the instantaneous intensity of the main pulse is between 0 and 5% of the peak intensity of the main pulse.

4. The method according to claim 1, wherein the second prepulse, as prepulse bundle with a diameter that is adapted to a target diameter (D_{V}) which is increased as a result of the reduced target density, is focused on the target.

5. The method according to claim 1, wherein the main pulse is formed by at least one CO₂ laser focused on the target.

6. The method according to claim 1, wherein main pulses of a plurality of CO₂ lasers are focused on the target successively with respect to time.

7. The method according to claim 1, wherein pulses of a plurality of CO₂ lasers are focused on the target simultaneously as a main pulse.

8. The method according to claim 1, wherein simultaneously generated pulses of a plurality of groups of CO₂ lasers are focused on the target successively as main pulses.

9. The method according to claim 8, wherein the prepulses of at least one solid-state laser are focused on the target.

10. The method according to claim 1, wherein the prepulses of at least one excimer laser are focused on the target.

11. An arrangement for the efficient generation of intensive short-wavelength radiation based on a laser-generated plasma in which at least one laser is directed to a near-solid-density target which is located in a vacuum chamber, wherein the target is struck by a prepulse for reducing the target density and a main pulse for generating a radiation-emitting plasma, comprising:
separate prepulse lasers and main-pulse lasers being provided;
at least one gas laser with a low critical electron density typical for its wavelength being provided as a main-pulse laser; and
a synchronization unit being connected to at least one main-pulse laser and to at least one prepulse laser for generating a pulse sequence of at least two prepulses and one main pulse;
least a second prepulse following a first prepulse being provided for a new or a further ionization of the target after a recombination of free electrons that has occurred in the target during the reduction of the target density.

12. The arrangement according to claim 11, wherein means for adapting a focus diameter which is realized on the target to a target diameter (D_{V}) which is increased due to the reduced target density are provided for at least one prepulse laser, so that the focus diameter is adapted to the increased target diameter (D_{V}) after the first prepulse for every additional laser pulse.

13. The arrangement according to claim 11, wherein at least one short-wavelength laser with a wavelength less than 1 μm is provided for generating the prepulses.

14. The arrangement according to claim 13, wherein the short-wavelength prepulse laser is a solid-state laser.

15. The arrangement according to claim 13, wherein the short-wavelength prepulse laser is an excimer laser.

16. The arrangement according to claim 11, wherein prepulse lasers and main-pulse lasers are directed to the target in collinearly guided beam bundles.

17. The arrangement according to claim 11, wherein prepulse lasers and main-pulse lasers are directed to the target in beam bundles that are guided separately next to one another.

18. The arrangement according to claim 11, wherein two prepulse lasers and two main-pulse lasers are provided to generate the prepulses and are directed, respectively, from opposite sides to an optical axis of a collector that is provided for focusing the radiation emitted by the plasma and to a target flow that is provided in a reproducible manner along a target axis, wherein the target axis intersects the optical axis of the collector and the prepulse lasers and main-pulse lasers are directed to this intersection point.

19. The arrangement according to claim 17, wherein the beam bundles of the prepulse lasers and main-pulse lasers which are directed to the target are arranged at an obtuse angle relative to one another so as to be symmetric in pairs with respect to an axis lying in a plane defined by the optical axis of the collector and the target axis, so that components of the beam bundles transmitted through the target cannot enter prepulse lasers and main-pulse lasers on the other side.

20. The arrangement according to claim 19, wherein the beam bundles of the prepulse lasers and main-pulse lasers directed to the target are arranged so as to be axially symmetric to the optical axis of the collector.

21. The arrangement according to claim 19, wherein the beam bundles of the prepulse lasers and main-pulse lasers directed to the target are arranged so as to be axially symmetric to the target axis.

22. The arrangement according to claim 18, wherein the collector is a concave mirror with a dielectric layer system.

23. The arrangement according to claim 18, wherein the collector is constructed in the form of a paraboloid.

24. The arrangement according to claim 18, wherein the collector comprises a plurality of shells with metallic coating.

25. The arrangement according to claim 24, wherein the metallic coating comprises palladium.

26. The arrangement according to claim 11, wherein the target material is guided along a vertical target axis in a reproducible manner in a discontinuous sequence of individual targets in the vacuum chamber.

27. The arrangement according to claim 26, wherein targets of tin or tin compounds are provided along the target axis.

28. The arrangement according to claim 26, wherein targets of liquefied xenon are provided along the target axis.

29. The arrangement according to claim 11, wherein the target material is in frozen form prior to the impact of the first prepulse.

30. The arrangement according to claim 28, wherein the target material is in frozen form prior to the impact of the first prepulse.
